(19) United States
(12) Patent Application Publication
(10) Pub. No.: US 2010/0133883 A1
(43) Pub. Date: Jun. 3, 2010

(54) Infant and Toddler Car Seat with integral cooling system / humidifier

(76) Inventor: Georgia Bell Walker, Phoenix, AZ (US)

Correspondence Address: Georgia Walker, 1831 W. Mulberry Dr. #240, Phoenix, AZ, 85015, US

(21) Appl. No.: 12/362,410

(22) Filed: Apr. 9, 2009

Related U.S. Application Data
(60) Provisional application No. 61/024,313, filed on Jan. 29, 2008.

(51) Int. Cl. B60N 2/56; F25D 31/00; A47C 7/72; B60N 2/28

(52) U.S. Cl. 297/180.1; 62/259.3; 62/259.4

(57) ABSTRACT

A plastic molded and upholstered car seat with variable sizes and colors featuring five point adjustable straps where cold air is blown in and around the underside of the seat exiting the lowest side at the front. Temperature controls are located on the side along with battery recharging outlets. Latching systems located in the rear of the seat for temporary attachment to the vehicle along with harness adjustments for existing automobile seat belts. Portability adjustments are located throughout the seat for moving the seat and carrying to and from building or automobiles.

### PREVIOUS FILING

This application emanates from a previously filed application 61/024,313 filed Jan. 29, 2008

### FIELD OF THE INVENTION

The present invention is directed to a system for cooling seating units of the type adapted for supporting the human body. More particularly, the present invention is directed to a system which operates in conjunction with a conventional or substantially conventional air conditioning system, to cool seats designed for infants and the like.

### BACKGROUND OF THE INVENTION

Air conditioning systems, including air conditioners for automobiles, are well known in the prior art. A feature of conventional air conditioners, and particularly of automobile air conditioners, is that they force ambient air through an evaporator which is chilled in the inside, and thereafter exude the chilled air from a vent or the like. Some individuals, however, would prefer not to have chilled air directed at them and therefore prefer an alternative way of cooling their environment. In addition, for understandable reasons, conventional automotive air conditioners provide virtually no cooling effect in convertible automobiles when the convertible top is down. Still further, occupants of certain types of luxury cars, and especially of race cars, would often prefer directs cooling of the seats, of the steering wheel and arms rests, instead of, or in addition to conventional air conditioning which utilizes chilled air blown out of air conditioning vents. Direct cooling of furniture units of the type which supports the human body, such as seats, sofas and the like, would also be preferred by certain individuals instead of, or in addition to traditional “forced air” air conditioning systems. As far as the present inventor is aware, the above-summarized needs have not been met in the prior art.

### SUMMARY OF THE INVENTION

It is an object of the present invention to provide a cooling system which is adapted for directly cooling child seats and like items such as seats, sofas and particularly seats of automobiles.

It is another object of the present invention to provide a cooling system which meets the foregoing objective and can be used in separate from conventional automotive air conditioning systems

The foregoing and other objects and advantages are attained by an infant and Toddler car seat with integral cooling system/humidifier which includes multiple components.

Innovative children's safety product that has been design to improve the cooling of the child when they are placed in the child safety seat in the vehicle. In warm climates the baby can be uncomfortable or even threaten by the heat in the rear seat of the vehicle If the vehicle A/C is not functioning effectively the heat can build quickly in the rear seat of the vehicle. The Infant and Toddler Car seat cooling system solves this problem.

Infant and toddler car seat with built in cooling system also can be use as a humidifier for children with breathing problems.

### BRIEF DESCRIPTION OF THE DRAWING

FIG. 1 is a front and side perspective view thereof;

FIG. 1 (1) is a front view of the device.

FIG. 2 (2) is the side view of the device.

FIG. 3 (3) is the right side view of the device.

FIG. 4 (4) is a cutout view of the air conditioning system of the device.

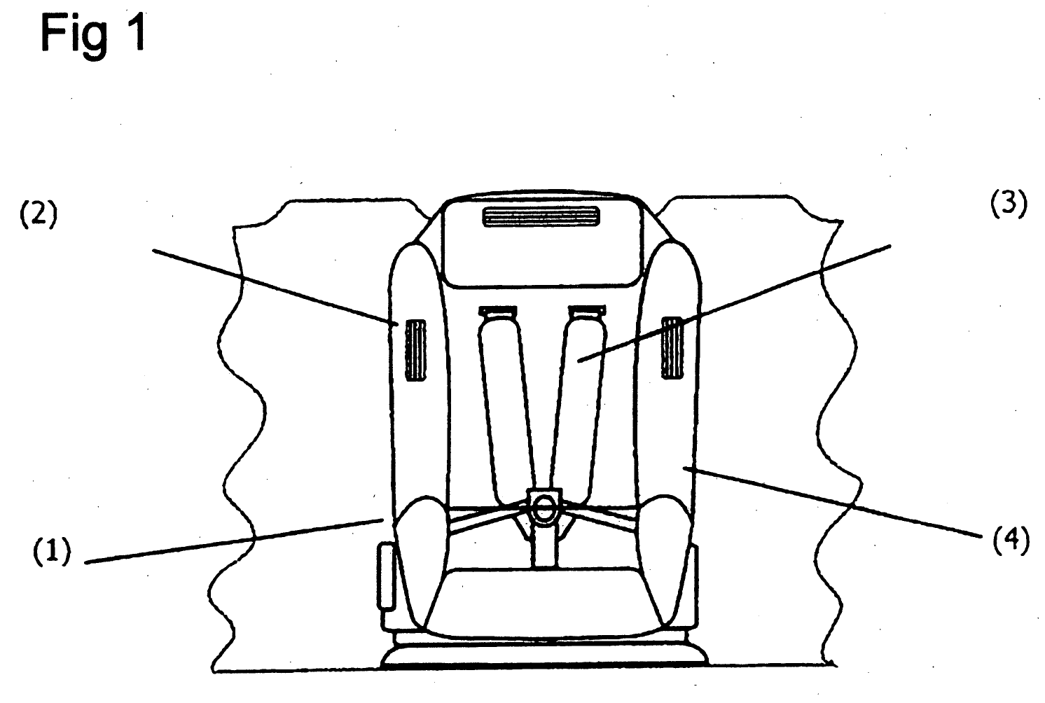

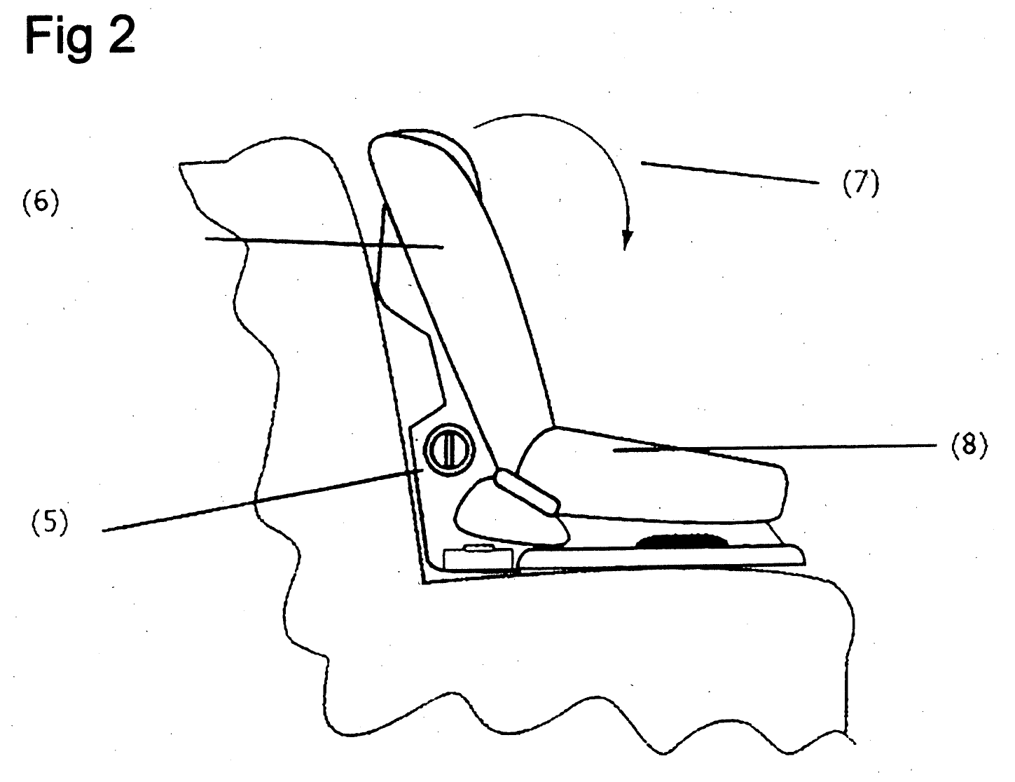

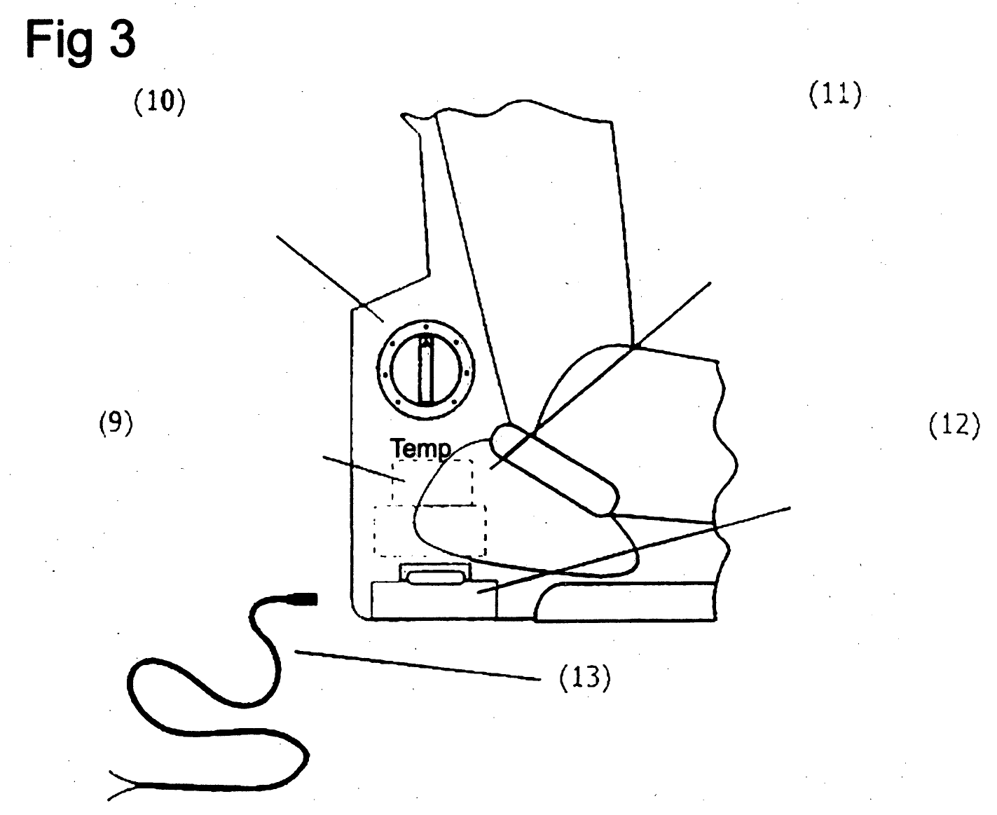

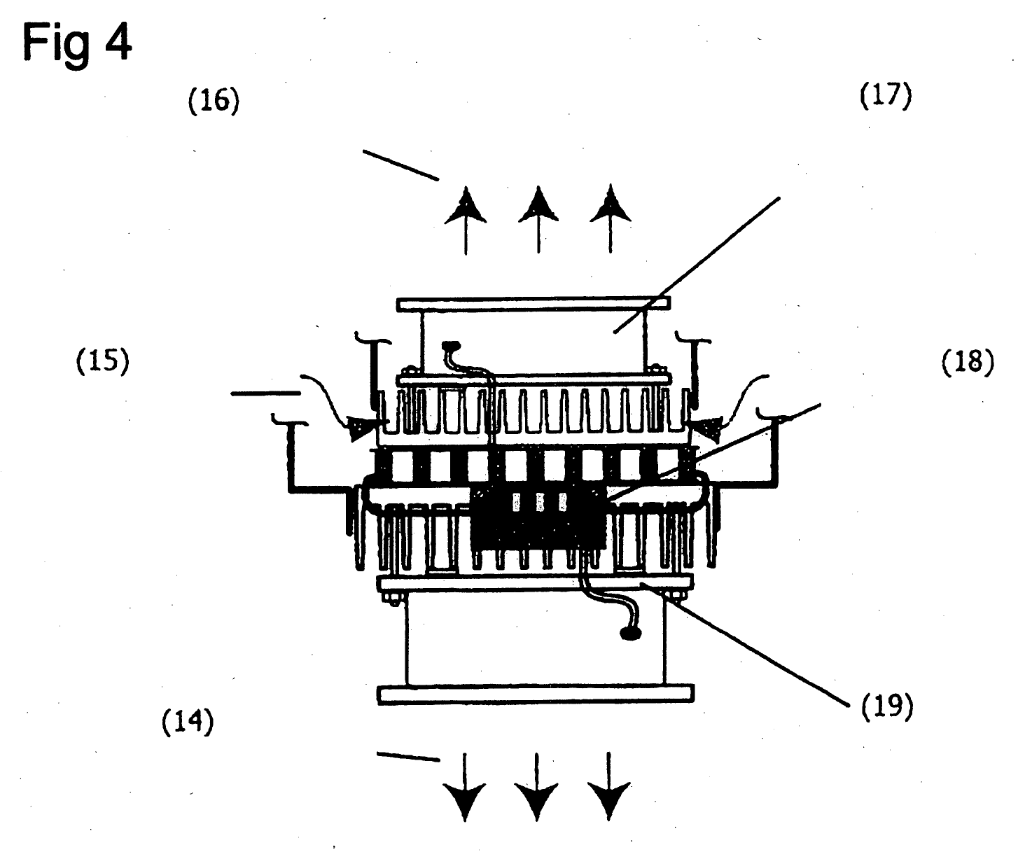

### DETAILED DESCRIPTION OF THE INVENTION

### Features

The plastic shell is molded just like the standard product, except the ductwork is molded into the shell. The car safety seat is supplied in infant or toddler sizes. The seat padded covers are supplied in various colors and patterns to blend into the vehicle's decor. The seat is supplied with a typical 5 point restraint harness for the safety of the child. The construction is standard except the molded plastic seat frame has the cool air ductwork molded into the risers and base. This allows the pre-assembled TE module to be placed in the base and effectively work to cool the air feeding into the ductworks, through the directive grills, allowing the cool air to cascade down over the child, forming a cool air cocoon around the child. The seats are supplied with two securing systems. The construction and securing systems meet or exceed all Nation Highway Traffic Safety Administration (NHTSA) tougher new standards.
The vents blow cool air in an arching pattern so the child is surrounded in a cooling bubble. The warm air rejected from the base of the cooler module is mixed in with the cabin air and does not appreciably affect the overall cabin temperature of the vehicle.
The 5 point belt system securely holds the child in place in case of an accident.
The seat is available in various sizes, colors, and fabrics to blend in or to complement the vehicle interior.
The temperature control is located on this side as is the rechargeable battery access.
The car seat is strapped in place using the rear seat belts or is secured using the LATCH system and the tethers.
The air flowing out of the central upper vent cascades down over the child as the cool air sinks.
The car seat can be un-strapped and carried along into the home or building. Upon departing the building, the seat can be plugged in and strapped down again for use in the vehicle.

1. An infant and toddler car seat with integral cooling system/humidifier adapted to be removably attached to a motor vehicle seat, comprising: a seat member having a seating surface defined by a bottom portion, a back portion having left and right wing extensions, two side portions, and five point adjustable straps secured to the seat member for holding a child occupant securely in the child restraint seat, at least said bottom and said back portions having a plurality of openings formed there through, said seat member further having a n air pocket formed on a side of the bottom and back portions opposite said seating surface;
Temperature control functions and battery recharging outlets located on said side and a duct member having at least first and second ends, at least one of said ends being mountable to an opening in said air pocket, and at least one of said ends being sized so as to accommodate the second end of said connection member;
Whereby temperature conditioned air from self contained heat/air conditioning system is directed through said connection member, duct member and air pocket to said seating surface.

2. And infant and toddler car seat with integral cooling system/humidifier as in claim 1, wherein said seat member further includes means for anchoring said seat into said motor vehicle.

3. And infant and toddler car seat with integral cooling system/humidifier as in claim 1, wherein said seat member further includes openings in said left and right side portions.

4. An infant and toddler car seat with integral cooling system/humidifier as in claim 1, wherein said seating surface is covered in an air permeable padding allowing said temperature conditioned air to pass through said padding and into said seating surface.
